(19) United States
(12) Patent Application Publication
(10) Pub. No.: US 2017/0110806 A1
(43) Pub. Date: Apr. 20, 2017

(54) ANISOTROPIC CONDUCTIVE FILM AND PRODUCTION METHOD OF THE SAME

(71) Applicant: DEXERIALS CORPORATION, Tokyo (JP)

(72) Inventors: Satoshi IGARASHI, Tokyo (JP); Junichi NISHIMURA, Utsunomiya-shi (JP)

(73) Assignee: DEXERIALS CORPORATION, Tokyo (JP)

(21) Appl. No.: 15/126,819

(22) PCT Filed: Mar. 20, 2015
(86) PCT No.: PCT/JP2015/058474

§ 371 Date: Sep. 16, 2016

(30) Foreign Application Priority Data
Mar. 20, 2014 (JP) 2014-058901

(51) Int. Cl. H01R 4/04; H01R 43/00

(52) U.S. Cl. CPC H01R 4/04; H01R 43/007

(57) ABSTRACT

An anisotropic conductive film has an insulating binder layer, conductive particles arranged in a regular pattern on a surface of the insulating binder layer, and an insulating adhesion layer layered on the surface of the insulating binder layer. In the insulating binder layer of the anisotropic conductive film, insulating fillers are arranged in a regular pattern so as not to be overlapped with the conductive particles. This anisotropic conductive film is produced by arranging the conductive particles and the insulating fillers in regular patterns using a transfer mold having openings. The anisotropic conductive film can suppress linking of the conductive particles during anisotropic conductive connection without an increase in connection resistance, to largely suppress occurrence of short circuit.

### TECHNICAL FIELD

The present invention relates to an anisotropic conductive film and a production method of the same.

### BACKGROUND ART

An anisotropic conductive film has been widely used in mounting of an electronic component such as an IC chip. In recent years, an anisotropic conductive film in which conductive particles for anisotropic conductive connection are arranged in a regular pattern, such as a square lattice, of a single layer on an insulating adhesion layer has been proposed (Patent Literature 1) in order to improve the connection reliability and the insulating property, increase the conductive particle capture efficiency, and decrease the production cost from the viewpoint of application to high mounting density.

This anisotropic conductive film is produced as follows. Specifically, the conductive particles are first held in openings of a transfer mold having the openings in the regular pattern, and an adhesive film having an adhesive layer for transfer is pressed onto the conductive particles to primarily transfer the conductive particles to the adhesive layer. Subsequently, a macromolecular film that is a component of the anisotropic conductive film is pressed onto the conductive particles attached to the adhesive layer, and heated and pressurized to secondarily transfer the conductive particles to a surface of the macromolecular film. An adhesion layer is formed on the surface of the macromolecular film, having the secondarily transferred conductive particles, on a side of the conductive particles so as to cover the conductive particles. Thus, the anisotropic conductive film is formed. In order to shorten a production process, it is tried to directly transfer and attach the conductive particles to the macromolecular film without using an adhesive layer.

### CITATION LIST

### Patent Literature

Patent Literature 1: Japanese Patent Application Laid-Open No. 2010-33793

### SUMMARY OF INVENTION

### Technical Problem

However, in the anisotropic conductive film of Patent Literature 1 that is produced using the transfer mold having the openings, the conductive particles are arranged in the regular pattern at predetermined intervals, but the conductive particles flow more than expected during anisotropic conductive connection. Therefore, Patent Literature 1 has a problem in which the conductive particles are linearly linked to one another to increase the occurrence ratio of short circuit.

During anisotropic conductive connection, compression-bonding may be performed at a pressure that exceeds a designed pressure of the anisotropic conductive film. In this case, there is a problem in which the conductive particles are excessively crushed to be broken and the original conduction performance is not obtained. The problem in which the conductive particles are excessively crushed especially arises when an electrode terminal of a flexible printed wiring substrate is connected to an electrode terminal of a glass substrate.

For such problems, dispersion of insulating fillers that are smaller than the conductive particles in the anisotropic conductive film is considered. When the insulating fillers are simply randomly dispersed, the conductive particles and the insulating fillers are overlapped with each other in a pushing direction during anisotropic conductive connection. For this reason, problems such as an increase in connection resistance and a decrease in connection reliability may arise.

An object of the present invention is to solve the problems in the conventional techniques, and in other words, is to provide an anisotropic conductive film produced by arranging conductive particles in a regular pattern using a transfer mold having openings, wherein linking of the conductive particles is suppressed during anisotropic conductive connection without an increase in connection resistance, to largely suppress occurrence of short circuit and solve a conduction failure due to excessive crushing of the conductive particles.

### Solution to Problem

The present inventors have found that when insulating fillers are arranged in a regular pattern on an insulating binder layer in which the conductive particles are arranged in a regular pattern so as not to be overlapped with the conductive particles, the object can be achieved. The present invention has thus been completed.

Specifically, the present invention provides an anisotropic conductive film having an insulating binder layer, conductive particles arranged in a regular pattern on a surface of the insulating binder layer, and an insulating adhesion layer layered on the surface of the insulating binder layer, wherein

in the insulating binder layer, insulating fillers are arranged in a regular pattern so as not to be overlapped with that of the conductive particles.

The present invention also provides a production method of the anisotropic conductive film, including the following steps (A) to (D).

### Step (A)

A step of disposing the conductive particles in first openings of a transfer mold having the first openings for accommodating the conductive particles and second openings for accommodating the insulating fillers, with the first openings being formed in a regular pattern and the second openings being formed in a regular pattern so as not to be overlapped with the first openings, and disposing the insulating fillers in the second openings.

### Step (B)

A step of providing the insulating binder layer formed on a release film so as to be opposed to a surface of the transfer mold on a side where the conductive particles and the insulating fillers are disposed.

### Step (C)

A step of pushing the insulating binder layer into the first and second openings by applying a pressure to the insulating binder layer from a side of the release film, to transfer and attach the conductive particles and the insulating fillers to a surface of the insulating binder layer.

### Step (D)

A step of layering the insulating adhesion layer on the surface of the insulating binder layer to which the conductive particles and the insulating fillers are transferred and attached.

The present invention also provides a connection structure in which a first electronic component and a second electronic component are connected by anisotropic conductive connection through the above-described anisotropic conductive film.

Moreover, the present invention provides a method of connecting a first electronic component and a second electronic component by anisotropic conductive connection through the above-described anisotropic conductive film, the method including temporarily adhering the anisotropic conductive film to the second electronic component from a side of the insulating adhesion layer, mounting the first electronic component on the anisotropic conductive film temporarily adhered, and thermo-compression bonding them from a side of the first electronic component.

### Advantageous Effects of Invention

The anisotropic conductive film of the present invention has the insulating binder layer, the conductive particles arranged in a regular pattern on a surface of the insulating binder layer, and the insulating adhesion layer layered on the surface of the insulating binder layer. In the insulating binder layer, the insulating fillers are arranged in a regular pattern so as not to be overlapped with the conductive particles. For this reason, linking of the conductive particles together can be suppressed and occurrence of short circuit can be largely suppressed without an increase in connection resistance. Further, breaking of the conductive particles on a bump during anisotropic conductive connection can be suppressed.

### BRIEF DESCRIPTION OF DRAWINGS

FIG. 1 is a cross-sectional view of an anisotropic conductive film of the present invention.

FIG. 2 is an example of regular pattern arrangements of conductive particles and insulating fillers.

FIG. 3 is an example of regular pattern arrangements of conductive particles and insulating fillers.

FIG. 4 is an example of regular pattern arrangements of conductive particles and insulating fillers.

FIG. 5 is an example of regular pattern arrangements of conductive particles and insulating fillers.

FIG. 6 is an example of regular pattern arrangements of conductive particles and insulating fillers.

FIG. 7A is an explanatory diagram of a production step (A) of the anisotropic conductive film of the present invention.

FIG. 7B is an explanatory diagram of a production step (B) of the anisotropic conductive film of the present invention.

FIG. 7C is an explanatory diagram of a production step (C) of the anisotropic conductive film of the present invention.

FIG. 7D is an explanatory diagram of a production step (D) of the anisotropic conductive film of the present invention.

FIG. 7E is an explanatory diagram of the production step (D) of the anisotropic conductive film of the present invention.

### DESCRIPTION OF EMBODIMENTS

Hereinafter, the anisotropic conductive film of the present invention will be described in detail. Note that in the respective drawings, the same or similar components are denoted by the same reference numerals.

### <<Anisotropic Conductive Film>>

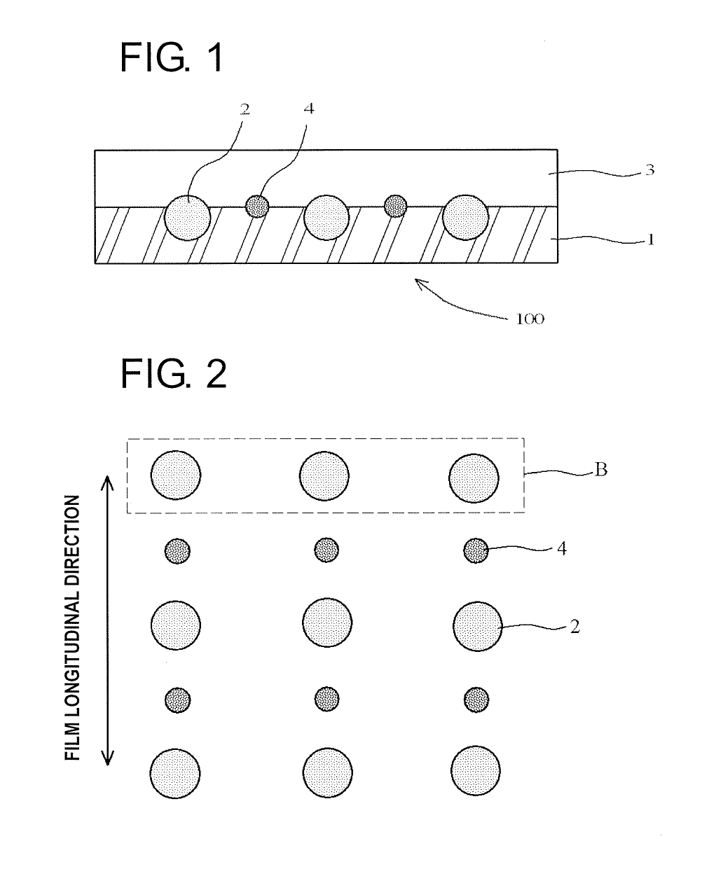

As shown in FIG. 1, an anisotropic conductive film 100 of the present invention has an insulating binder layer 1, conductive particles 2 arranged in a regular pattern on a surface of the insulating binder layer 1, and an insulating adhesion layer 3 layered on the surface of the insulating binder layer 1. In the insulating binder layer 1, insulating fillers 4 are arranged in a regular pattern so as not to be overlapped with the conductive particles 2. The conductive particles 2 and the insulating fillers 4 may be contained in the insulating binder layer 1. However, in order to produce the anisotropic conductive film 100 by a production method of the anisotropic conductive film described below, it is preferable that the conductive particles 2 and the insulating fillers 4 be locally located on the surface, as shown in FIG. 1, as a result of avoiding an excessive transfer pressure when the conductive particles 2 and the insulating fillers 4 in the transfer mold are transferred and attached to the insulating binder at the step (C).

### <<Conductive Particles>>

As the conductive particles 2, conductive particles used in conventionally known anisotropic conductive films can be appropriately selected and used. Examples of the conductive particles may include metal particles such as nickel, cobalt, silver, copper, gold, and palladium particles, and metal-coated resin particles. Two or more kinds thereof may be used in combination.

A preferable hardness of the conductive particles is varied depending on the kind of a substrate or a terminal to be connected by anisotropic conductive connection. When a flexible printed circuit (FPC) and a glass substrate are connected by anisotropic conductive connection (FOG), comparatively soft particles having a compression hardness during deformation of 20% (K value) of 1,500 to 4,000 N/mm² are preferred. When FPC and FPC are connected by anisotropic conductive connection (FOE), comparatively soft particles having a compression hardness during deformation of 20% (K value) of 1,500 to 4,000 N/mm² are also preferred. When an IC chip and a glass substrate are connected by anisotropic conductive connection, comparatively hard conductive particles having a compression hardness during deformation of 20% (K value) of 3,000 to 8,000 N/mm² are preferred. In a case of electronic components in which an oxide film is formed on a surface of a wiring regardless of material qualities, harder conductive particles having a compression hardness during deformation of 20% (K value) of 8,000 N/mm² or more are preferred.

Herein, the compression hardness during deformation of 20% (K value) is a value calculated by the following equation (1) from a load at which the particle diameter of the conductive particles is decreased by 20% as compared with the original particle diameter by loading the conductive particles in one direction to compress the conductive particles. As the K value is smaller, the particles are softer.

K=(3/√2)F·S^{-8/2}·R^{-1/2} (1)

(In the equation, F is a load during compression deformation of the conductive particles by 20%, S is a compression displacement (mm), and R is a diameter (mm) of the conductive particles.)

In order to correspond to dispersion of wiring heights, suppress an increase in conduction resistance, and suppress occurrence of short circuit, the average particle diameter of the conductive particles 2 is preferably 1 μm or more and 10 μm or less, and more preferably 2 μm or more and 6 μm or less. The average particle diameter can be measured by a general particle size distribution measurement device.

In order to suppress a decrease in conductive particle capture efficiency and suppress occurrence of short circuit, the amount of the conductive particles 2 existing in the insulating binder layer 1 is preferably 50 particles or more and 40,000 particles or less, and more preferably 200 particles or more and 20,000 particles or less, per square millimeter.

### <Regular Pattern of Conductive Particles 2>

A regular pattern that is the arrangement state of the conductive particles 2 means an arrangement in which the conductive particles 2 that can be recognized when the conductive particles 2 are seen through from a surface of the anisotropic conductive film 100 exist at points of a lattice such as a rectangular lattice, a square lattice, a hexagonal lattice, and a rhombic lattice. Virtual lines constituting the lattices are not limited to straight lines, but may be curves or bent lines.

The ratio of the conductive particles 2 arranged in the regular pattern to the whole conductive particles 2 is preferably 90% or more in terms of the number of the conductive particles for stabilization of anisotropic conductive connection. This ratio can be measured using an optical microscope or the like.

The interparticle distance of the conductive particles 2 is preferably 0.5 times or more, and more preferably 1 time or more and 5 times or less, the average particle diameter of the conductive particles 2.

### <<Insulating Fillers>>

As the insulating fillers 4, insulating fillers used in conventionally known anisotropic conductive films can be appropriately selected and used. Examples thereof may include resin particles, and particles of metal oxides such as aluminum oxide, titanium oxide, and zinc oxide. Examples of shapes thereof may include spherical, elliptical, flat, columnar, and needle shapes. A spherical shape is preferred.

### <Hardness and Diameter of Insulating Fillers>

When the particle diameter of the insulating fillers 4 is smaller than those of the conductive particles 2, it is desirable that the preferable hardness of the insulating fillers 4 be larger than that of the conductive particles so that excessive crushing of the conductive particles 2 resulting in breaking during compression-bonding for anisotropic conductive connection can be prevented. When the particle diameter of the insulating fillers 4 is larger than those of the conductive particles 2, the hardness of the insulating fillers 4 may be equal to or less than that of the conductive particles 2, and preferably less than that of the conductive particles 2. The preferable hardness of the insulating fillers 4 is varied depending on the hardness of electronic components to be connected by anisotropic conductive connection and heating and pressurization conditions. Therefore, it is desirable that the size and hardness of the insulating fillers 4 be appropriately designed on the basis of a combination of the electronic components to be connected by anisotropic conductive connection, heating and pressurization conditions during connection, and the size and hardness of the conductive particles.

Specifically, when the insulating fillers 4 are softer than the conductive particles 2, the average particle diameter of the insulating fillers 4 may be smaller than that of the conductive particles 2, or be equal to or larger than that of the conductive particles 2. On the other hand, when the insulating fillers 4 are harder than the conductive particles 2, it is preferable that the average particle diameter of the insulating fillers 4 be smaller than that of the conductive particles 2. Herein, the hardness of the insulating fillers 4 relative to the conductive particles 2 can be judged by comparison of the compression hardness during compression deformation (K value) and a crushing ratio under a predetermined pressure applied. When the hardness of the insulating fillers 4 is the same as that of the conductive particles 2, it is desirable that the average particle diameter of the insulating fillers are smaller than that of the conductive particles.

When the average particle diameter of the insulating fillers 4 is made smaller than that of the conductive particles 2, the preferable average particle diameter of the insulating fillers 4 is 0.3 μm or more and 7 μm or less, and more preferably 0.9 μm or more and 4.2 μm or less, in order to suppress excessive pushing of the conductive particles 2 between a wiring and a bump and occurrence of breaking, suppress the excessive flow of the conductive particles 2, and achieve pushing suitable for connection of the conductive particles 2. The average particle diameter can be measured by a general particle size distribution measurement device.

In particular, in order to enable the conductive particles 2 to be favorably pushed during anisotropic conductive connection and suppress excessive attachment of the insulating fillers 4 to the wiring and the bump, the average particle diameter of the insulating fillers 4 is preferably 75% or less, and more preferably 30% or more and 70% or less of that of the conductive particles 2 regardless of the degree of hardness of the insulating fillers 4 relative to the conductive particles 2. When the insulating fillers 4 are as sufficiently soft as the conductive particles 2, it is preferable that the average particle diameter of the insulating fillers 4 be 120% or less of that of the conductive particles 2. Thus, in addition to the conductive particles 2, the insulating fillers 4 are held between the bump and the wiring, and the thermal conductivity in the vicinity of the bump is made favorable. Specifically, when anisotropic conductive connection is performed, unwanted heat is difficult to remain at a connection portion, and this also contributes to conduction reliability.

### <Resin Forming Insulating Filler>

When the insulating fillers are formed from resin particles, it is preferable that a method of producing the insulating fillers by adjusting the hardness of the insulating fillers corresponding to the hardness, diameter, and the like of the conductive particles be a method of producing resin particles forming the insulating fillers using a plastic material having excellent compression deformation. For example, such a plastic material may be formed of a (meth)acrylate-based resin, a polystyrene-based resin, a styrene-(meth)acrylic copolymer resin, a urethane-based resin, an epoxy-based resin, a phenolic resin, an acrylonitrile-styrene (AS) resin, a benzoguanamine resin, a divinylbenzene-based resin, a styrene-based resin, a polyester resin, or the like.

Among them, it is preferable that the (meth)acrylate-based resin be a copolymer of a (meth)acrylate-based monomer, and if necessary, a compound having a reactive double bond copolymerizable with the (meth)acrylate-based monomer, and a bifunctional or multifunctional monomer.

Examples of the (meth)acrylate-based monomer may include methyl (meth)acrylate, ethyl (meth)acrylate, propyl (meth)acrylate, butyl (meth)acrylate, 2-ethylhexyl (meth)acrylate, lauryl (meth)acrylate, stearyl (meth) acrylate, cyclohexyl (meth) acrylate, 2-hydroxyethyl (meth)acrylate, 2-propyl (meth)acrylate, chloro-2-hydroxyethyl (meth)acrylate, diethylene glycol mono(meth)acrylate, methoxyethyl (meth) acrylate, glycidyl (meth)acrylate, dicyclopentanyl (meth)acrylate, dicyclopentenyl (meth)acrylate, and isobornyl (meth) acrylate.

Further, it is preferable that the polystyrene-based resin be a copolymer of a styrene-based monomer, and if necessary, a compound having a reactive double bond copolymerizable with the styrene-based monomer, and a bifunctional or multifunctional monomer.

Examples of the styrene-based monomer may include styrene, alkyl styrenes such as methylstyrene, dimethylstyrene, trimethylstyrene, ethylstyrene, diethylstyrene, triethylstyrene, propylstyrene, butylstyrene, hexylstyrene, heptylstyrene, and octylstyrene; halogenated styrenes such as florostyrene, chlorostyrene, bromostyrene, dibromostyrene, iodestyrene, and chloromethylstyrene; nitrostyrene, acetylstyrene, and methoxystyrene.

The insulating fillers may be formed of only one of the (meth)acrylate-based resin and the styrene-based resin described above, a copolymer of monomers forming these resins, or a composition containing the (meth)acrylate-based resin and the styrene-based resin.

When the monomer forming the (meth)acrylate-based resin and the monomer forming the styrene-based resin are copolymerized, another copolymerizable monomer may be copolymerized, if necessary.

Examples of the other monomer may include a vinyl-based monomer and an unsaturated carboxylic acid monomer.

Examples of a polymer of the (meth)acrylate-based resin with another compound may include a polymer of a urethane compound with an acrylate-based monomer. As the urethane compound, multifunctional urethane acrylate may be used, for example, bifunctional urethane acrylate or the like may be used. In production of the polymer of the urethane compound with the acrylate-based monomer, it is preferable that the urethane compound be contained in an amount of 5 parts by weight or more, and more preferably 25 parts by weight or more, relative to 100 parts by weight of the acrylate-based monomer.

In the present invention, a (meth)acrylic acid ester-based monomer represents both of an acrylic acid ester (acrylate) and a methacrylic acid ester (methacrylate). In the present invention, the monomer also includes an oligomer that is a polymer of two or more monomers as long as it is polymerized by heating, irradiation with ultraviolet light, or the like.

### <Amount of Insulating Fillers>

In order to hold a connection state, radiate heat generated near the connection portion resulting in stabilization, and suppress occurrence of short circuit, the amount of the insulating fillers 4 existing in the insulating binder layer 1 is preferably 10 particles or more and 800,000 particles or less, and more preferably 20 particles or more and 400,000 particles or less, per square millimeter.

### <Arrangement of Insulating Fillers 4 in Regular Pattern>

A regular pattern that is the arrangement state of the insulating fillers 4 means an arrangement in which the insulating fillers 4 that can be recognized when the insulating fillers 4 are seen through from a surface of the anisotropic conductive film 100 exist at points of a lattice such as a rectangular lattice, a square lattice, a hexagonal lattice, and a rhombic lattice like the conductive particles 2. Virtual lines constituting the lattices are not limited to straight lines, but may be curves or bent lines.

The regular pattern of the insulating fillers 4 is a disposition in which the insulating fillers 4 are not overlapped with the conductive particles 2. The matter in which the regular pattern of the conductive particles 2 is not overlapped with the regular pattern of the insulating fillers 4 in the anisotropic conductive film means that the center of gravity of the conductive particles 2 and the center of gravity of the insulating fillers 4 disposed in the respective regular patterns are not overlapped with each other in a thickness direction of the anisotropic conductive film. The conductive particles and the insulating fillers may be partially overlapped with each other in the thickness direction of the anisotropic conductive film as long as the centers of gravity thereof are not overlapped with each other. Specifically, it is desirable that the conductive particles 2 and the insulating fillers 4 be not overlapped with each other completely in a plane view in terms of favorable anisotropic conductive connection. However, when this is required for the whole surface of the anisotropic conductive film, a yield in production deteriorates to increase the cost. On the other hand, when the conductive particles and the insulating fillers are partially overlapped with each other but the centers of gravity thereof are not overlapped with each other, the conductive particles 2 are laterally slipped by resin flow during pushing, and anisotropic conductive connection is not inhibited because at least the conductive particles 2 are generally spherical.

In order to avoid a failure of anisotropic conductive connection during connection, the ratio of the insulating fillers 4 arranged in the regular pattern relative to the whole insulating fillers 4 is preferably 90% or more in terms of the number of the insulating fillers. This ratio can be measured using an optical microscope or the like.

### <Examples of Arrangement of Conductive Particles and Insulating Fillers in Regular Patterns>

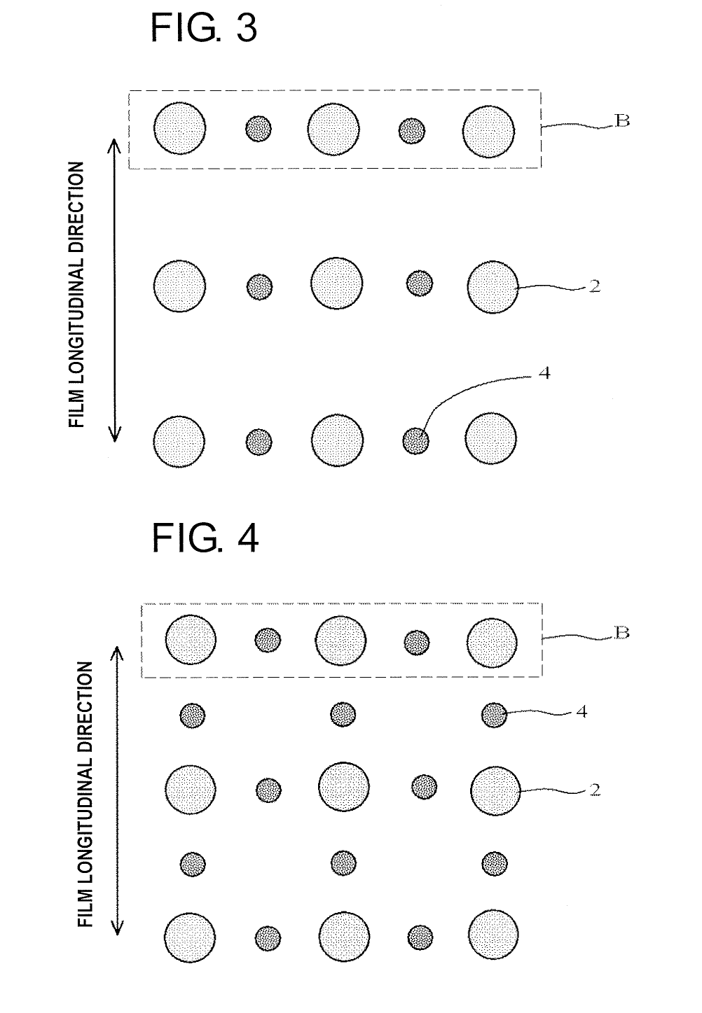

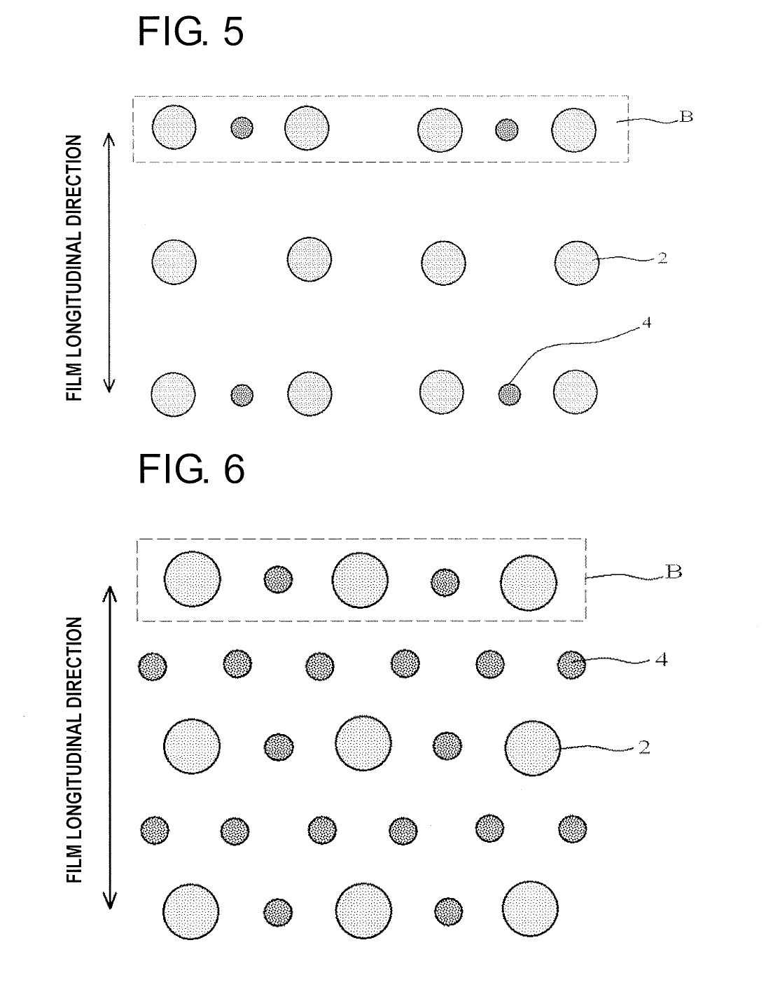

Examples of the regular patterns of the conductive particles and the insulating fillers in the anisotropic conductive film of the present invention may include an aspect in which the regular patterns of the conductive particles and the insulating fillers are the same kind of lattice arrangement and the lattice pitches thereof are equal to each other (FIGS. 2 and 3), an aspect in which the regular patterns of the conductive particles and the insulating fillers are the same kind of lattice arrangement and the lattice pitches thereof are different from each other (FIGS. 4 and 5), an aspect in which the regular patterns of the conductive particles and the insulating fillers are the same kind of lattice arrangement and the lattice directions thereof are different from each other (FIG. 4), and an aspect in which the regular patterns of the conductive particles and the insulating fillers are different kinds of lattice arrangements (FIG. 6). Specific examples thereof may include (A) an aspect in which the insulating fillers are arranged between the conductive particles that are arranged in at least a film longitudinal direction among the conductive particles arranged in the regular pattern (see FIG. 2), (B) an aspect in which the insulating fillers are arranged between the conductive particles that are arranged in at least a direction orthogonal to the film longitudinal direction among the conductive particles arranged in the regular pattern (see FIG. 3), (C) an aspect in which the insulating fillers are arranged between the conductive particles that are arranged in the film longitudinal direction among the conductive particles arranged in the regular pattern and between the conductive particles that are arranged in the direction orthogonal to the film longitudinal direction (see FIG. 4), (D) an aspect in which insulating fillers that are arranged in the same direction as that of arrangement of the conductive particles are included and the distance between the insulating fillers is larger than the distance between the conductive particles in the arrangement direction (see FIG. 5), and (E) an aspect in which insulating fillers that are arranged in the same direction as that of arrangement of the conductive particles are included and the distance between the insulating fillers is smaller than the distance between the conductive particles in the arrangement direction (see FIG. 6).

In the aspects (A) to (E), when the insulating fillers 4 between the conductive particles are arranged in the film longitudinal direction (the insulating fillers are disposed between the conductive particles arranged in the film longitudinal direction), an effect capable of suppressing contact of the conductive particles between bumps can be obtained. When the insulating fillers 4 between the conductive particles are arranged in the direction orthogonal to the film longitudinal direction (the insulating fillers are disposed between the conductive particles arranged in the direction orthogonal to the film longitudinal direction), the insulating fillers are easy to be held between the bumps that are the same as in a case of the conductive particles, and an effect capable of making the pushing degree of the conductive particles within the bumps uniform can be obtained.

The number of the insulating fillers 4 between the conductive particles is not limited to one, and a plurality of the insulating fillers 4 may exist depending on the distance between the conductive particles. The number of the insulating fillers can be optionally varied according to the design of the bumps.

The insulating fillers 4 may be provided at an interval that is wider than that of the conductive particles 2. In terms of preventing short circuit by the insulating fillers 4, this is because, when the insulating fillers are provided between the conductive particles arranged in a direction of distance between the bumps, the insulating fillers that have a wider lattice pitch than that of the conductive particles in the direction can also be expected to have an effect of preventing short circuit. For the uniformity of pushing, the number of the insulating fillers 4 held on the bumps is preferably 2 or more, and more preferably 3 or more.

Among arrangements constituting the regular pattern of the conductive particles, it is preferable that an arrangement in a direction passing through an optional conductive particle and another conductive particle that is the closest to the optional conductive particle (that is, an arrangement that has the shortest pitch of the conductive particles) be in the longitudinal direction of the anisotropic conductive film, or be parallel or substantially parallel to the direction orthogonal to the longitudinal direction of the anisotropic conductive film, and more preferably in a direction inclined to the longitudinal direction of the anisotropic conductive film or the direction orthogonal to the longitudinal direction. In general, the longitudinal direction of a terminal to be connected by anisotropic conductive connection and the direction orthogonal to the longitudinal direction of the anisotropic conductive film can be matched. Therefore, when the film is adhered to a substrate or the like, a shift between the conductive particles and the terminal in the film longitudinal direction tends to be larger than a shift thereof in the direction orthogonal to the film longitudinal direction. Accordingly, in order to prevent difficult capture during anisotropic conductive connection when the arrangements of the conductive particles and the insulating fillers exist at an edge end portion of the terminal in a short direction (film longitudinal direction), it is preferable that the arrangement direction of the closest pitch of the conductive particles be matched to the film longitudinal direction, or be inclined to the film longitudinal direction and the direction orthogonal to the film longitudinal direction.

Next, examples of the regular patterns of the conductive particles and the insulating fillers will be described further in detail with reference to FIGS. 2 to 4. In the drawings, each arrow is a longitudinal direction of the anisotropic conductive film during production. Each rectangle B surrounded by dotted lines is one example of bump position assumed during anisotropic conductive connection.

FIG. 2 is an aspect in which the regular pattern of the conductive particles 2 is a square lattice pattern, the regular pattern of the insulating fillers 4 is a square lattice pattern, the lattice pitches of the patterns are equal to each other, and the conductive particles 2 and the insulating fillers 4 are alternately disposed in the longitudinal direction of the anisotropic conductive film (arrow direction in the drawing).

FIG. 3 is an aspect in which the regular pattern of the conductive particles 2 is a square lattice pattern, the regular pattern of the insulating fillers 4 is a square lattice pattern, the lattice pitches of the patterns are equal to each other, and the conductive particles 2 and the insulating fillers 4 are alternately disposed in the direction orthogonal to the longitudinal direction of the anisotropic conductive film (arrow direction in the drawing).

FIG. 4 is an aspect in which the regular pattern of the conductive particles 2 is a square lattice pattern, the regular pattern of the insulating fillers 4 is also a square lattice pattern, the lattice directions thereof deviate from each other by 45°, and the lattice pitch of the conductive particles 2 is equal to the pitch in a diagonal direction of lattice of the insulating fillers 4. In this aspect, the insulating fillers 4 and the conductive particles 2 are each a square lattice, and the lattice pitches thereof are equal to each other. However, the square lattice pattern of the insulating fillers is shifted by a half of pitch of the square lattice pattern of the conductive particles in a lattice direction, and the insulating fillers are on face centers of unit lattice faces of the square lattice pattern of the insulating fillers. Therefore, this aspect is an aspect in which the regular pattern of the insulating fillers appears to be a face-centered square lattice pattern.

### <Insulating Binder Layer 1>

The insulating binder layer 1 constituting the anisotropic conductive film 100 of the present invention is a resin layer having a function of fixing the conductive particles 2 and the insulating fillers 4 in the film 100. The configuration of an insulating resin layer used in a publicly known anisotropic conductive film can be appropriately adopted. For example, the conductive particles and the insulating fillers can be fixed by polymerizing a thermally or photo-polymerizable resin such as a thermally or photo-cationically, anionically, or radically polymerizable resin so that the polymerization ratio preferably becomes 50% or more and 100% or less. Because of polymerization, the resin is difficult to flow even under heating during anisotropic conductive connection. Therefore, the mounting conductive particle capture efficiency can be improved, and the occurrence of short circuit can be largely suppressed. Accordingly, the conduction reliability between electrodes of the substrate and the bumps and the insulating properties between the electrodes of the substrate or between the bumps can be improved. It is particularly preferable that the insulating binder layer 1 be a photo-radically polymerized resin layer obtained by photo-radically polymerizing a photo-radically polymerizable resin layer containing an acrylate compound and a photo-radical polymerization initiator. Hereinafter, a case where the insulating binder layer 1 is the photo-radically polymerized resin layer will be described.

### (Acrylate Compound)

As an acrylate compound that is an acrylate unit, a conventionally known photo-radically polymerizable acrylate can be used. For example, a monofunctional (meth)acrylate (herein, (meth)acrylate includes acrylate and methacrylate), or a multifunctional (meth)acrylate having two or more functional groups can be used. In the present invention, in order to make the insulating binder layer 1 thermosettable, it is preferable that a multifunctional (meth)acrylate be used in at least a portion of acrylic monomers.

When the content of the acrylate compound in the insulating binder layer 1 is too small, it is difficult that the conductive particles 2 and the insulating fillers 4 are fixed in the insulating binder layer 1 so that they do not flow during anisotropic conductive connection by a molten resin. When the content thereof is too large, the curing shrinkage increases and the workability tends to decrease. Therefore, the content thereof is preferably 2% by mass or more and 70% by mass or less, and more preferably 10% by mass or more and 50% by mass or less.

### (Photo-Radical Polymerization Initiator)

As the photo-radical polymerization initiator, a publicly known photo-radical polymerization initiator can be appropriately selected and used. Examples of the publicly known photo-radical polymerization initiator may include an acetophenone-based photopolymerization initiator, a benzylketal-based photopolymerization initiator, and a phosphorus-based photopolymerization initiator.

When the amount of the photo-radical polymerization initiator to be used is too small relative to 100 parts by mass of the acrylate compound, photo-radical polymerization does not sufficiently proceed. When the amount is too large, stiffness may decrease. Therefore, the amount is preferably 0.1 parts by mass or more and 25 parts by mass or less, and more preferably 0.5 parts by mass or more and 15 parts by mass or less.

In the insulating binder layer 1, if necessary, a film-forming resin such as a phenoxy resin, an epoxy resin, an unsaturated polyester resin, a saturated polyester resin, a urethane resin, a butadiene resin, a polyimide resin, a polyamide resin, and a polyolefin resin can be used in combination. In the insulating adhesion layer 3 described below, the resin may also be used similarly.

When the thickness of the insulating binder layer 1 is too small, the mounting conductive particle capture efficiency tends to decrease. When the thickness is too large, the conduction resistance tends to increase. Therefore, the thickness is preferably 1.0 μm or more and 6.0 μm or less, and more preferably 2.0 μm or more and 5.0 μm or less.

The insulating binder layer 1 may further contain an epoxy compound and a thermal or photo-cationic or anionic polymerization initiator. In this case, it is preferable that the insulating adhesion layer 3 be also a thermally or photo-cationically or anionically polymerizable resin layer containing an epoxy compound and a thermal or photo-cationic or anionic polymerization initiator, as described below. Thus, the delamination strength can be enhanced. The epoxy compound and the thermal or photo-cationic or anionic polymerization initiator will be described in relation to the insulating adhesion layer 3.

As shown in FIG. 1, it is preferable that the conductive particles 2 fixed in the insulating binder layer 1 eats into the insulating adhesion layer 3 (i.e., the conductive particles 2 be exposed to a surface of the insulating binder layer 1). This is because, when all portions of the conductive particles are embedded in the insulating binder layer, the connection resistance may increase. When an eating-into degree is too small, the mounting conductive particle capture efficiency tends to decrease. When the degree is too large, the conduction resistance tends to increase. Therefore, the degree is preferably 10% or more and 90% or less, and more preferably 20% or more and 80% or less, of the average particle diameter of the conductive particles.

The insulating binder layer 1 can be formed by, for example, attaching the conductive particles and the insulating fillers to the photo-radically polymerizable resin layer containing a photo-radically polymerizable acrylate and a photo-radical polymerization initiator by a procedure such as a film transfer method, a mold transfer method, an inkjet method, and an electrostatic attachment method, and irradiating the photo-radically polymerizable resin layer with ultraviolet light from a side of the conductive particles, an opposite side thereof, or both the sides.

### <Insulating Adhesion Layer 3>

The insulating adhesion layer 3 is a resin layer having a function of connecting or bonding electronic components opposed to each other during anisotropic conductive connection. The configuration of an insulating resin layer used in a publicly known anisotropic conductive film can be appropriately adopted. It is preferable that the insulating adhesion layer 3 be formed of a thermally or photo-cationically, anionically, or radically polymerizable resin layer, and preferably a thermally or photo-cationically or anionically polymerizable resin layer containing an epoxy compound and a thermal or photo-cationic or anionic polymerization initiator, or a thermally or photo-radically polymerizable resin layer containing an acrylate compound and a thermal or photo-radical polymerization initiator.

Herein, when the aforementioned insulating binder layer 1 is formed of a photo-polymerized resin layer, it is desirable that the insulating adhesion layer 3 be formed of the thermally polymerizable resin layer in terms of convenience of production and quality stability because a polymerization reaction does not occur in the insulating adhesion layer 3 by irradiation with ultraviolet light for formation of the insulating binder layer 1.

When the insulating adhesion layer 3 is the thermally or photo-cationically or anionically polymerizable resin layer, the insulating adhesion layer 3 may further contain an acrylate compound and a thermal or photo-radical polymerization initiator. Thus, the delamination strength of the insulating binder layer 1 can be improved.

### (Epoxy Compound)

When the insulating adhesion layer 3 is the thermally or photo-cationically or anionically polymerizable resin layer containing an epoxy compound and a thermal or photo-cationic or anionic polymerization initiator, preferred examples of the epoxy compound may include a compound or a resin having two or more epoxy groups in the molecule. The compound and the resin may be liquid or solid.

### (Thermal Cationic Polymerization Initiator)

As the thermal cationic polymerization initiator, a publicly known thermal cationic polymerization initiator for an epoxy compound can be adopted. For example, the thermal cationic polymerization initiator generates an acid, which can cationically polymerize a cationically polymerizable compound, by heat. A publicly known iodonium salt, sulfonium salt, phosphonium salt, ferrocenes, or the like can be used. An aromatic sulfonium salt that exhibits favorable latency for temperature can be preferably used.

When the amount of the thermal cationic polymerization initiator to be added is too small, curing tends to be difficult. When the amount is too large, the product life tends to be reduced. Therefore, the amount is preferably 2 parts by mass or more and 60 parts by mass or less, and more preferably 5 parts by mass or more and 40 parts by mass or less, relative to 100 parts by mass of the epoxy compound.

### (Thermal Anionic Polymerization Initiator)

As the thermal anionic polymerization initiator, a publicly known thermal anionic polymerization initiator for an epoxy compound can be adopted. For example, the thermal anionic polymerization initiator generates a base, which can anionically polymerize an anionically polymerizable compound, by heat. A publicly known aliphatic amine compound, aromatic amine-based compound, secondary or tertiary amine-based compound, imidazole-based compound, polymercaptan-based compound, boron trifluoride-amine complex, dicyandiamide, organic acid hydrazide, or the like can be used. An encapsulated imidazole-based compound that exhibits favorable latency for temperature can be preferably used.

When the amount of the thermal anionic polymerization initiator to be added is too small, curing tends to be difficult. When the amount is too large, the product life tends to be reduced. Therefore, the amount is preferably 2 parts by mass or more and 60 parts by mass or less, and more preferably 5 parts by mass or more and 40 parts by mass or less, relative to 100 parts by mass of the epoxy compound.

### (Photo-Cationic Polymerization Initiator and Photo-Anionic Polymerization Initiator)

As the photo-cationic polymerization initiator or the photo-anionic polymerization initiator for an epoxy compound, a publicly known polymerization initiator can be appropriately used.

### (Acrylate Compound)

When the insulating adhesion layer 3 is the thermally or photo-radically polymerizable resin layer containing an acrylate compound and a thermal or photo-radical polymerization initiator, the acrylate compound described in relation to the insulating binder layer 1 can be appropriately selected and used.

### (Thermal Radical Polymerization Initiator)

Examples of the thermal radical polymerization initiator may include an organic peroxide and an azo-based compound. An organic peroxide that does not generate nitrogen causing bubbles can be preferably used.

When the amount of the thermal radical polymerization initiator to be used is too small, curing is difficult. When the amount is too large, the product life is reduced. Therefore, the amount is preferably 2 parts by mass or more and 60 parts by mass or less, and more preferably 5 parts by mass or more and 40 parts by mass or less, relative to 100 parts by mass of the acrylate compound.

### (Photo-Radical Polymerization Initiator)

As the photo-radical polymerization initiator for an acrylate compound, a publicly known photo-radical polymerization initiator can be used.

When the amount of the photo-radical polymerization initiator to be used is too small, curing is difficult. When the amount is too large, the product life is reduced. Therefore, the amount is preferably 2 parts by mass or more and 60 parts by mass or less, and more preferably 5 parts by mass or more and 40 parts by mass or less, relative to 100 parts by mass of the acrylate compound.

On another surface of the insulating binder layer 1, another insulating adhesion layer may be layered. Thus, an effect capable of finely controlling the fluidity of the whole layer can be obtained. Herein, the other insulating adhesion layer may have the same configuration as that of the insulating adhesion layer 3 described above.

### <<Production Method of Anisotropic Conductive Film>>

Next, an example of a production method of the anisotropic conductive film of the present invention will be described. This production method includes the following steps (A) to (D). Hereinafter, each step will be described.

### <Step (A)>

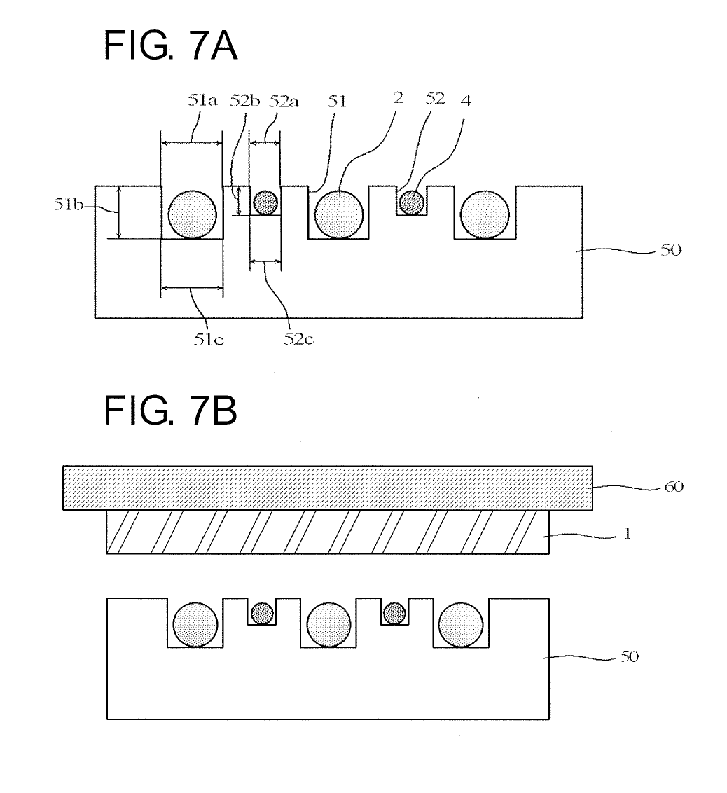

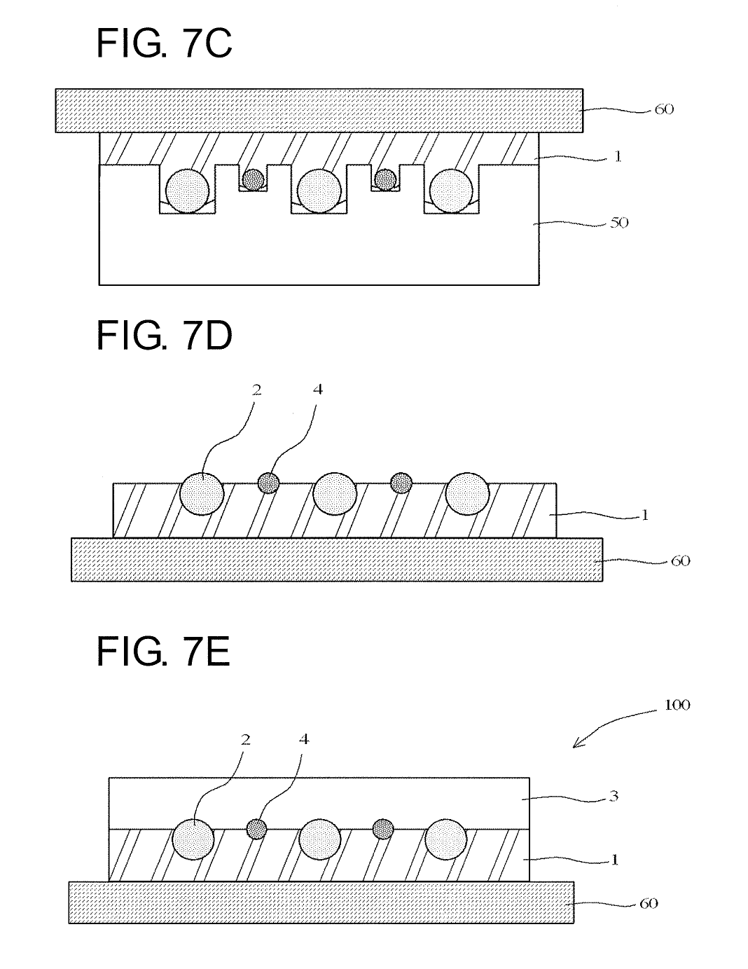

As shown in FIG. 7A, the conductive particles 2 are disposed in first openings 51 of a transfer mold 50 having the first openings 51 for accommodating the conductive particles 2 and second openings 52 for accommodating the insulating fillers 4, with the first openings 51 being formed in the regular pattern and the second openings 52 being formed in the regular pattern so as not to be overlapped with the first openings 51, and the insulating fillers 4 are disposed in the second openings 52.

When the particle diameter of the insulating fillers 4 is smaller than that of the conductive particles 2, and the opening diameter of the first openings 51 is smaller than that of the second openings 52, the conductive particles 2 are disposed in the first openings 51, and the insulating fillers 4 are then disposed in the second openings 52. In this case, the insulating fillers 4 may enter into the first openings 51 in which the conductive particles 2 are accommodated. However, such a case should not be excluded from the scope of the present invention as long as the effects of the present invention are not impaired.

It is preferable that the conductive particles 2 and the insulating fillers 4 be configured in the thickness direction of the anisotropic conductive film such that the center of gravity of the insulating fillers 4 and the center of gravity of the conductive particles 2 are not overlapped with each other in the thickness direction of the film (pushing direction during anisotropic conductive connection). Specifically, portions of the insulating fillers 4 and the conductive particles 2 other than the centers of gravity of the insulating fillers 4 and the conductive particles 2 may be overlapped with each other as long as the centers of gravity thereof are not overlapped with each other in the film thickness direction of the anisotropic conductive film. This is because of the reasons as follows. That is, overlapping of the center of gravity of the conductive particles and the center of gravity of the insulating fillers may inhibit anisotropic conductive connection. When the center of gravity of the insulating fillers 4 and the center of gravity of the conductive particles 2 are not overlapped with each other in the pushing direction, the insulating fillers 4 can flow together with the binder resin and the insulating adhesion layer by heating during anisotropic conductive connection to a position at which anisotropic conductive connection is not inhibited due to the shapes of the conductive particles 2 being generally substantially spherical.

Specifically, this is because of the following reasons. That is, the shapes of the conductive particles 2 are generally substantially spherical. Therefore, when a large number of insulating fillers partially overlapped with the conductive particles do not continuously exist, a pressure by a pressing tool is unlikely to be made ununiform during connection between the bumps. As a result, the insulating fillers 4 are shifted from the conductive particles 2 during flowing so as not to be overlapped with the conductive particles 2. The number of the insulating fillers 4 that are partially overlapped with the conductive particles 2 and continuously exist in the same direction of the arrangement is preferably 6 or less, more preferably 5 or less, and further preferably 4 or less, which have no problem in practical terms.

### (Transfer Mold)

The transfer mold 50 is, for example, a mold in which an opening is formed in an inorganic material such as silicon, various ceramics, glass, and metal including stainless steel, or an organic material such as various resins by a publicly known opening-forming method such as a photolithography method. The transfer mold 50 like this may have a shape of a plate, a roll, or the like.

Examples of each shape of the first opening 51 and the second opening 52 of the transfer mold 50 may include a columnar shape, a polygonal prism shape such as a quadrangular prism shape, and a pyramidal shape such as a quadrangular pyramidal shape.

The arrangements of the first openings 51 and the second openings 52 are arrangements corresponding to the regular patterns of the conductive particles 2 and the insulating fillers 4, respectively.

The diameters and depths of the first openings 51 and the second openings 52 of the transfer mold 50 can be measured by a laser microscope. Herein, when the openings are each a column, the deepest part is the depth.

A procedure for accommodating each of the conductive particles 2 in the first opening 51 of the transfer mold 50 and a procedure for accommodating each of the insulating fillers 4 in the second opening 52 are not particularly limited, and a publicly known procedure can be adopted. For example, a dried powder of the conductive particles or a dispersion liquid in which the powder is dispersed in a solvent is sprayed on or applied to the surface having the opening of the transfer mold 50, and the surface having the opening may be wiped using a brush, a blade, or the like.

### (First Opening)

The ratio of the diameter 51a of the first opening (first opening diameter) to the average particle diameter of the conductive particles 2 (=first opening diameter/average diameter of the conductive particles) is preferably 1.1 or more and 2.0 or less, more preferably 1.2 or more and 1.8 or less, and particularly preferably 1.3 or more and 1.7 or less in terms of balance between easy accommodation of the conductive particles, easy pushing of an insulating resin, prevention of attachment of the insulating fillers, and the like.

The ratio of the average particle diameter of the conductive particles 2 to the depth 51b of the first opening 51 (first opening depth) (=average diameter of the conductive particles/first opening depth) is preferably 0.4 or more and 3.0 or less, and more preferably 0.5 or more and 1.5 or less in terms of balance between improved transferring properties, conducive particle retention capability, prevention of the attachment of insulating fillers, and the like. When the ratio is less than 1, it is assumed that the insulating fillers are attached onto the conductive particles. However, since the conductive particles are generally spherical, the centers of gravity of the conductive particles and the insulating fillers are unlikely to be overlapped with each other. When the ratio is 1 or more, a gap in the first openings that are filled with the conductive particles is small. Therefore, the conductive particles and the insulating fillers are unlikely to be attached to each other.

It is preferable that a bottom diameter 51c of the first openings 51 on a base side (bottom diameter of the first openings) be equal to or more than the first opening diameter 51a. The ratio of the bottom diameter 51c of the first opening to the average particle diameter of the conductive particles 2 (=first opening bottom diameter/average particle diameter of the conductive particles) is preferably 1.1 or more and 2.0 or less, more preferably 1.2 or more and 1.7 or less, and particularly preferably 1.3 or more and 1.6 or less in terms of balance between easy accommodation of the conductive particles, easy pushing of the insulating resin, the prevention of attachment of insulating fillers, and the like.

### (Second Opening)

The ratio of the diameter 52a of the second opening (second opening diameter) to the average particle diameter of the insulating fillers 4 (=second opening diameter/average particle diameter of the insulating fillers) is also preferably 1.1 or more and 2.0 or less, and more preferably 1.3 or more and 1.8 or less in terms of balance between easy accommodation of the insulating fillers, easy pushing of the insulating resin, and the like.

The ratio of the average particle diameter of the insulating fillers 4 to the depth 52b of the second opening 52 (second opening depth) (=average particle diameter of the insulating fillers/second opening depth) is also preferably 0.4 or more and 3.0 or less, and more preferably 0.5 or more and 1.5 or less in terms of balance between improved transferring properties and insulting fillers retention capability.

The ratio of the bottom diameter 52c of the second opening 52 on a base side (second opening bottom diameter) to the average particle diameter of the insulating fillers (=second opening bottom diameter/average particle diameter of the insulating fillers) is preferably 1.1 or more and 2.0 or less, more preferably 1.2 or more and 1.7 or less, and particularly preferably 1.3 or more and 1.6 or less in terms of balance between easy accommodation of the conductive particles, easy pushing of the insulating resin, and the like.

### <Step (B)>

### Step (B)

As shown in FIG. 7B, the insulating binder layer 1 formed on a release film 60 is disposed so as to be opposed to a surface of the transfer mold 50 on a side where the conductive particles 2 and the insulating fillers 4 are disposed.

### <Step (C)>

As shown in FIG. 7C, the insulating binder layer 1 is pushed onto the first openings 51 and the second openings 52 by applying a pressure to the insulating binder layer 1 from a side of the release film 60, so as to transfer and attach the conductive particles 2 and the insulating fillers 4 to a surface of the insulating binder layer 1.

### <Step (D)>

As shown in FIG. 7D, the insulating binder layer 1 is detached from the transfer mold, and the insulating adhesion layer 3 is layered on the surface of the insulating binder layer in which the conductive particles 2 and the insulating fillers 4 are transferred and attached. Thus, the anisotropic conductive film 100 shown in FIG. 7E is obtained. If necessary, the release film 60 may be removed.

It is preferable that the insulating binder layer 1 be subjected to a pre-curing treatment (heating, irradiation with ultraviolet light, or the like) between the steps (C) and (D). Thus, the conductive particles 2 can be temporarily fixed in the insulating binder layer 1.

If necessary, the release film 60 is released, and another insulating adhesion layer may be layered on a surface where the release film is released (another surface of the insulating binder layer) (not shown).

### <<Application of Anisotropic Conductive Film>>

The anisotropic conductive film thus obtained can be preferably applied to anisotropic conductive connection between the first electronic component such as an FPC, an IC chip, and an IC module and the second electronic component such as an FPC, a rigid substrate, a ceramic substrate, and a glass substrate by heat or light. A connection structure obtained as described above is also a part of the present invention.

In the method of connecting the electronic components using the anisotropic conductive film, for example, when the anisotropic conductive film having a layer configuration shown in FIG. 1 is used, it is preferable that the anisotropic conductive film be temporarily adhered to the second electronic component such as a wiring substrate from a side of the insulating binder layer, the first electronic component such as an IC chip be mounted on the anisotropic conductive film temporarily adhered, and they be thermo-compression bonded from a side of the first electronic component in terms of the enhanced connection reliability. Further, connection can also be achieved by light curing.

### EXAMPLES

Hereinafter, the present invention will be described more specifically by Examples.

### Examples 1 to 9

60 Parts by mass of a phenoxy resin (YP-50, Nippon IPPON Steel & Sumikin Chemical Co. Ltd.), 40 parts by mass of an acrylate (EP600, DAICEL-ALLNEX LTD.), and 2 parts by mass of a photo-radical polymerization initiator (IRGACURE 369, BASF Japan LTD.) were mixed in toluene to prepare a mixed liquid having a solid content of 50% by mass. As a release film, a polyethylene terephthalate film (PET film) having a thickness of 50 μm was prepared. This mixed liquid was applied to the PET film so that a dried thickness was 5 μm, and dried in an oven at 80° C. for 5 minutes to form a photo-radically polymerizable insulating binder layer on the PET film (release film).

A stainless steel transfer mold with first columnar openings having a diameter of 5.5 μm and a depth of 4.5 μm at horizontal and vertical pitches of 9 μm for conductive particles and second columnar openings having a diameter of 3.0 μm and a depth of 4.0 μm for insulating fillers in patterns shown in FIG. 2 (Examples 1, 4, and 7), FIG. 3 (Examples 2 and 5), FIG. 4 (Examples 3 and 6), or FIG. 5 (Example 9) was prepared.

As a modification example (Example 8) of the patterns of FIG. 2, a transfer mold in which a distance between the first openings was 18 μm and three second openings were each provided between the first openings at an interval of 2.25 μm was prepared.

Each of conductive particles having an average particle diameter of 4 μm (Ni/Au plating resin particles, AUL 704, SEKISUI CHEMICAL CO., LTD.) was accommodated in each of the first openings of the transfer mold. Each of silica particles having an average particle diameter of 2.8 μm (Examples 1 to 3) or 1.2 μm (Examples 4 to 9) (KE-P250 or KE-P100, NIPPON SHOKUBAI CO., LTD.) was accommodated in each of the second openings. A surface having the openings of this transfer mold and the insulating binder layer were faced to each other, and pressurized from a side of the release film under a condition of 0.5 MPa at 60° C. to push the conductive particles and the insulating fillers onto the insulating binder layer.

Subsequently, the layer was irradiated with ultraviolet light having a wavelength of 365 nm at an integrated light amount of 4,000 mJ/cm² from the side of the release film. Thus, the insulating binder layer in which the conductive particles and the insulating fillers were temporarily fixed in a surface was formed.

60 Parts by mass of a phenoxy resin (YP-50, Nippon Steel & Simikin Chemical Co. Ltd.), 40 parts by mass of an epoxy resin (jER828, Mitsubishi Chemical Corporation), and 2 parts by mass of a photo-cationic polymerization initiator (SI-60, SANSHIN CHEMICAL INDUSTRY CO., LTD.) were mixed in toluene to prepare a mixed liquid having a solid content of 50% by mass. This mixed liquid was applied to a PET film having a thickness of 50 μm so that a dried thickness was 12 μm, and dried in an oven at 80° C. for 5 minutes, to form a comparatively thick insulating adhesion layer. A thin insulating adhesion layer having a dried thickness of 3 μm was formed by the same operation.

The comparatively thick insulating adhesion layer thus obtained was laminated on the temporarily fixed surface of the insulating binder layer, in which the conductive particles and the insulating fillers were temporarily fixed, under conditions of 60° C. and 0.5 MPa, and subsequently, the thin insulating adhesion layer was similarly laminated on the opposite surface to obtain an anisotropic conductive film.

In the anisotropic conductive film, the number of the insulating fillers existing between the conductive particles is as shown in FIGS. 2 to 5.

### Comparative Example 1

An anisotropic conductive film was obtained in the same manner as in Example 1 using a transfer mold having no opening for insulating fillers and not using insulating fillers.

### <Evaluation>

For the anisotropic conductive film of each of Examples and Comparative Examples, (a) number of linked conductive particles, (b) number of insulating fillers in contact with conductive particles, (c) initial conduction resistance, (d) conduction reliability, and (e) short circuit occurrence ratio were each tested and evaluated as follows. The results are shown in Table 1.

### (a) Number of Linked Conductive Particles

The anisotropic conductive film of each of Examples and Comparative Examples was placed between an IC for evaluation of initial conduction and conduction reliability and a glass substrate, and heated and pressurized (at 180° C. and 80 MPa for 5 seconds) to obtain a connection body for evaluation. Among 100 conductive particles on a bump, the number of linked conductive particles was measured. In this case, the linked conductive particles were counted as one particle. It is preferable that the number be smaller. Herein, patterns of terminals of the IC for each evaluation and the glass substrate corresponded to each other, and the sizes thereof were as follows.

IC for evaluation of initial conduction and conduction reliability

Outside diameter: 0.7×20 mm

Thickness: 0.2 mm

Bump specification: gold-plating, height: 12 μm, size: 15×100 μm, bump gap: 15 μm

Glass substrate

Glass material: available from Corning Incorporated

Outside diameter: 30 x 50 mm

Thickness: 0.5 mm

Electrode: ITO wiring

(b) Number of Insulating Fillers in Contact with Conductive Particles

Among 100 conductive particles on the bump in the connection body for evaluation produced in (a), the number of conductive particles in contact with the insulating fillers was measured. In this case, even when a plurality of insulating fillers are in Contact with one conductive particle, the insulating fillers were counted as one insulating filler.

### (c) Initial Conduction Resistance

The conduction resistance of the connection body for evaluation produced in (a) was measured by a digital multimeter (trade name: digital multimeter 7561, Yokogawa Electric Corporation).

### (d) Conduction Reliability

The connection body for evaluation of (a) was left in a constant temperature bath of a temperature of 85° C. and a humidity of 85%RH for 500 hours. After then, the conduction resistance was measured similarly to the measurement of (c). A conduction resistance of 5Ω or more was not preferred in terms of practical conduction stability of a connected electronic component.

### (e) Short Circuit Occurrence Ratio

As an IC for evaluation of short circuit occurrence ratio, the following IC (comb-teeth TEG (test element group) having a space of 7.5 μm) was prepared.

Outside diameter: 1.5×13 mm

Thickness: 0.5 mm

Bump specification: gold-plating, height: 15 μm, size: 25×140 μm, bump gap: 7.5 μm

The anisotropic conductive film of each of Examples and Comparative Examples was placed between an IC for evaluation of short circuit occurrence ratio and a glass substrate of a pattern corresponding to the pattern of the IC for evaluation, and heated and pressurized under the same connection condition as that in (b), to obtain a connection body. The short circuit occurrence ratio of the connection body was determined. The short circuit occurrence ratio was calculated by “occurrence number of short circuit/total number of space of 7.5 μm.” It is desirable that the short circuit occurrence ratio be less than 50 ppm in practical terms.

TABLE 1

| | | | | | | | | | | Comparative |
|---|---|---|---|---|---|---|---|---|---|---|
| | Example | | | | | | | | | Example |
| | 1 | 2 | 3 | 4 | 5 | 6 | 7 | 8 | 9 | 1 |
| Arrangement Pattern (Number of Drawing) | 2 | 3 | 4 | 2 | 3 | 4 | 2 | (2) | 5 | — |
| Number of Linked Conductive Particles | 0 | 0 | 0 | 0 | 0 | 0 | 0 | 0 | 2 | 6 |
| Number of Insulating Fillers in contact with | 15 | 7 | 7 | 20 | 10 | 10 | 30 | 40 | 40 | — |
| Conductive Particles | | | | | | | | | | |
| Initial Conduction Resistance (Ω) | 0.2 | 0.2 | 0.2 | 0.2 | 0.2 | 0.2 | 0.2 | 0.2 | 0.2 | 0.2 |
| Conduction Reliability (Ω) | <4 | <4 | <4 | <4 | <4 | <4 | <4 | <4 | <4 | <5 |
| Short Circuit Occurrence Ratio (ppm) | <20 | <20 | <20 | <20 | <20 | <20 | <20 | <20 | <20 | <50 |

As seen from Table 1, among the anisotropic conductive films of Examples 1 to 9, two linked conductive particles were observed in Example 9, and such conductive particles were not observed in any other Examples. Even when the number of insulating fillers in contact with the conductive particles is increased or decreased, the evaluations for “initial conduction resistance,” “conduction reliability,” and “short circuit occurrence ratio” were preferred. On the other hand, in the anisotropic conductive film of Comparative Example 1, since the insulating fillers were not arranged, 6 linked conductive particles were observed. Due to this, the conduction reliability was decreased, and the occurrence of short circuit was increased.

### Examples 10 to 15 and Comparative Examples 2 to 5

### (Production of Anisotropic Conductive Film)

### (i) Production of Resin Core

To a solution in which a mixing ratio of divinyl benzene, styrene, and butyl methacrylate was adjusted, benzoyl peroxide as a polymerization initiator was added, and the mixture was heated while uniformly stirred at high speed, resulting in a polymerization reaction. Thus, a fine particle dispersion liquid was obtained. The fine particle dispersion liquid was filtered and dried under reduced pressure to obtain a block body as an agglomerate of the fine particles. Further, the block body was pulverized and classified to obtain divinyl benzene-based resin particles having an average particle diameter of 3, 4, or 5 μm as a resin core. The hardness of the particles was adjusted by adjusting the mixing ratio of divinyl benzene, styrene, and butyl methacrylate.

### (ii) Production of Conductive Particles

A palladium catalyst was supported on the divinyl benzene-based resin particles (5 g) obtained in (i) by an immersion method. Next, the resin particles were subjected to electroless nickel plating using an electroless nickel plating liquid (pH: 12, plating liquid temperature: 50° C.) prepared from nickel sulfate hexahydrate, sodium hypophosphite, sodium citrate, triethanol amine, and thallium nitrate. Thus, nickel-coating resin particles having a nickel-plating layer (metal layer) on a surface were obtained.

Subsequently, the nickel-coating resin particles (12 g) obtained above was mixed in a solution in which 10 g of sodium tetrachloroaurate was dissolved in 1,000 mL of ion-exchanged water, to prepare an aqueous suspension. To the obtained aqueous suspension, 15 g of ammonium thiosulfate, 80 g of ammonium sulfite, and 40 g of ammonium hydrogenphosphate were added, to prepare a gold plating bath. To the obtained gold plating bath, 4 g of hydroxylamine was added. After that, the pH of the gold plating bath was adjusted to 9 using ammonia, and the temperature of the bath was maintained at 60° C. for about 15 to 20 minutes to obtain gold/nickel-coating resin particles. An operation such as classification was appropriately performed to obtain conductive particles having an average particle diameter of 4 μm or 5 μm.

(iii) Production of Anisotropic Conductive Film

An anisotropic conductive film was produced in the same manner as in Example 1 except that a resin core having an average particle diameter of 3 μm or 5 μm produced in (i) was used as insulating fillers, the insulating fillers and conductive particles having an average particle diameter of 4 or 5 μm produced in (ii) were arranged in the arrangement patterns shown in FIG. 2, and an insulating adhesion layer had the following composition.

Phenoxy resin (YP-50, NIPPON STEEL & SUMITOMO METAL CORPORATION): 60 parts by mass

Encapsulated imidazole-based curing agent (NOVACURE HX3941HP, Asahi Kasei E-materials Corporation): 40 parts by mass

In Table 2, the particle areal density of the conductive particles and the particle areal density of the insulating fillers are designed number densities (particles/mm²) of the conductive particles and the insulating fillers in the anisotropic conductive film.

### (Evaluation)

The anisotropic conductive films obtained in Examples 10 to 15 and Comparative Examples 2 to 5 were assumed to be used in connection of a terminal of a flexible printed wiring board with a terminal of a glass substrate (FOG: film on glass). The following glass substrate and the following FPC were thermo-compression bonded at a pressure that was changed into 4 cases in accordance with the heating and pressurization conditions shown in FIG. 2.

Glass substrate: Mo/Ti coating, glass thickness: 0.7 mm

FPC: terminal pitch: 50 μm, terminal width:space between terminals=1:1, polyimide film thickness/copper foil thickness (PI/Cu)=38/8, Sn plating

Among the heating and pressurization conditions, a condition of 170° C., 3 MPa, and 5 seconds was the lower limit of variable pressures of FOG connection, a condition of 170° C., 5 MPa, and 5 seconds was one of standards of variable pressures of FOG connection, a condition of 170° C., 8 MPa, and 5 seconds was a condition of comparatively high pressure among variable pressures of FOG connection, and a condition of 170° C., 10 MPa, and 5 seconds was the upper limit of variable pressures of FOG connection.

The initial conduction resistance and conduction reliability of the obtained connection bodies for evaluation were determined in the same manner as in Example 1.

Herein, the initial conduction and the conduction reliability were evaluated into the following three grades in accordance with a value of each conduction resistance. The results are shown in Table 2.

### Initial Conduction

A: less than 1Ω

B: 1Ω or more and less than 5Ω

C: 5Ω or more

### Conduction Reliability

A: less than 2.5Ω

B: 2.5Ω or more and less than 10Ω

C: 10Ω or more

Further, crushing of the conductive particles in the connection bodies for evaluation was measured using SEM after polishing of cross section. A crushing ratio relative to the initial particle diameter ((particle diameter of conductive particles in connection body for evaluation/initial conductive particle diameter)×100) was calculated. The crushing was evaluated into the following five grades in accordance with the crushing ratio.

C1: crushing ratio of less than 20% (particles were broken)

B1: crushing ratio of 20% or more and less than 40%

A: crushing ratio of 40% or more and less than 60%

B2: crushing ratio of 60% or more and less than 80%

C2: crushing ratio of 80% or more (few particles were broken)

TABLE 2

| | | | Comparative | Comparative | Comparative | Comparative | Exam- |
|---|---|---|---|---|---|---|---|
| | | Unit | Example 2 | Example 3 | Example 4 | Example 5 | ple 10 |
| Arrangement Patterns of Conductive Particles and | | | 2 | 2 | 2 | 2 | 2 |
| Insulating Fillers (Number of Drawing) | | | | | | | |
| Conductive Particles | Conductive Particle | μm | 4 | 4 | 4 | 5 | 4 |
| | Diameter | | | | | | |
| | Particle Hardness | N/mm² | 3500 | 5000 | 9000 | 3500 | 3500 |
| | (20% K Value) | | | | | | |
| | Conductive Property | — | Presence | Presence | Presence | Presence | Presence |
| | (Presence or | | | | | | |
| | Absence of Plating) | | | | | | |
| | Particle Areal Density | Particles/mm² | 8000 | 8000 | 8000 | 8000 | 4000 |
| Insulating Fillers | Particle Diameter | μm | — | — | — | — | 3 |
| | Particle Hardness | N/mm² | — | — | — | — | 5000 |
| | (20% K Value) | | | | | | |
| | Particle Areal Density | Particles/mm² | — | — | — | — | 4000 |
| Total Number of | Particle Areal Density | Particles/mm² | 8000 | 8000 | 8000 | 8000 | 8000 |
| Particles | | | | | | | |
| Evaluation | | | | | | | |
| Heating and | Initial Conduction | | A | B | C | A | A |
| Pressurization Condition | Conduction Reliability (85° C., 85% RH, 500 hr.) | | A | B | C | A | A |
| 170° C./3 Mpa/5 sec. | Crushing of Particles | | A | B2 | C2 | B2 | A |
| 170° C./5 Mpa/5 sec. | Initial Conduction | | A | A | B | A | A |
| | Conduction Reliability (85° C., 85% RH, 500 hr.) | | A | B | C | A | A |
| | Crushing of Particles | | B1 | A | B2 | A | A |
| 170° C./8 Mpa/5 sec. | Initial Conduction | | C | B | C | B | B |
| | Conduction Reliability (85° C., 85% RH, 500 hr.) | | C | B | C | B | B |
| | Crushing of Particles | | C1 | B1 | A | B1 | B1 |
| 170° C./10 Mpa/5 sec. | Initial Conduction | | C | B | A | C | A |
| | Conduction Reliability (85° C., 85% RH, 500 hr.) | | C | C | C | C | B |
| | Crushing of Particles | | C1 | C1 | B2 | C1 | B1 |

| | | | Exam- | Exam- | Exam- | Exam- | Exam- |
|---|---|---|---|---|---|---|---|
| | | Unit | ple 11 | ple 12 | ple 13 | ple 14 | ple 15 |
| Arrangement Patterns of Conductive Particles and | | | 2 | 2 | 2 | 2 | 2 |
| Insulating Fillers (Number of Drawing) | | | | | | | |
| Conductive Particles | Conductive Particle | μm | 4 | 4 | 5 | 5 | 4 |
| | Diameter | | | | | | |
| | Particle Hardness | N/mm² | 3500 | 3500 | 3500 | 3500 | 3500 |
| | (20% K Value) | | | | | | |
| | Conductive Property | — | Presence | Presence | Presence | Presence | Presence |
| | (Presence or | | | | | | |
| | Absence of Plating) | | | | | | |
| | Particle Areal Density | Particles/mm² | 4000 | 4000 | 4000 | 4000 | 4000 |
| Insulating Fillers | Particle Diameter | μm | 3 | 3 | 3 | 3 | 5 |
| | Particle Hardness | N/mm² | 9000 | 12000 | 9000 | 3500 | 3500 |
| | (20% K Value) | | | | | | |
| | Particle Areal Density | Particles/mm² | 4000 | 4000 | 4000 | 4000 | 4000 |
| Total Number of | Particle Areal Density | Particles/mm² | 8000 | 8000 | 8000 | 8000 | 8000 |
| Particles | | | | | | | |
| Evaluation | | | | | | | |
| Heating and | Initial Conduction | | A | A | A | A | A |
| Pressurization Condition | Conduction Reliability (85° C., 85% RH, 500 hr.) | | A | B | A | A | A |
| 170° C./3 Mpa/5 sec. | Crushing of Particles | | A | B2 | B2 | A | A |
| 170° C./5 Mpa/5 sec. | Initial Conduction | | A | A | A | A | A |
| | Conduction Reliability (85° C., 85% RH, 500 hr.) | | A | A | A | A | A |
| | Crushing of Particles | | A | A | A | B1 | A |
| 170° C./8 Mpa/5 sec. | Initial Conduction | | A | A | A | A | B |
| | Conduction Reliability (85° C., 85% RH, 500 hr.) | | A | A | A | A | B |
| | Crushing of Particles | | A | A | A | B1 | B1 |
| 170° C./10 Mpa/5 sec. | Initial Conduction | | A | A | A | B | A |

| Conduction Reliability (85° C., 85% RH, 500 hr.) | A | A | A | C | B |
|---|---|---|---|---|---|
| Crushing of Particles | A | A | A | C1 | B1 |

As seen from Table 2, in Examples 10 to 15 in which the insulating fillers were contained, the conductive particles are appropriately crushed by pressing within a range of 3 MPa to 10 MPa, and therefore, both the initial conduction resistance and the conduction reliability are excellent as compared with Comparative Examples 2 to 5 in which the insulating fillers were not contained.

More specifically, in Comparative Example 2, the conductive particle diameter, the hardness of the conductive particles, and the areal density of the conductive particles are the same as those in a conventional and general anisotropic conductive film. As seen from Comparative Example 2, when the pressure of the heating and pressurization condition is as comparatively high as 8 MPa, the conductive particles are excessively crushed.

As seen in Comparative Example 3, since the conductive particles in Comparative Example 3 is harder than Comparative Example 2, excessive crushing of the conductive particles during anisotropic conductive connection is less than Comparative Example 2. However, when the pressure of the heating and pressurization condition during anisotropic conductive connection is as high as 10 MPa, the conduction reliability deteriorates.

As seen in Comparative Example 4, since the conductive particles in Comparative Example 4 are much harder than Comparative Example 3, the conductive particles are unlikely to be crushed during anisotropic conductive connection. When the pressure of the heating and pressurization condition is changed into a higher pressure, the initial conduction resistance is improved, but the conduction reliability deteriorates.

Comparative Example 5 was configured such that the conductive particles in Comparative Example 4 were softened and the conductive particle diameter thereof was increased. The conductive particles are easy to be crushed during anisotropic conductive connection as compared with Comparative Example 4. When the pressure of the heating and pressurization condition is changed into low to middle pressures, the initial conduction resistance is improved, but the conduction reliability at high pressure deteriorates.

On the other hand, in Examples 10 to 13, the insulating fillers are harder than the conductive particles, and the particle diameter of the insulating fillers are smaller than that of the conductive particles. Therefore, the conductive particles are appropriately crushed during anisotropic conductive connection, and both the initial conduction properties and the conduction reliability are favorable. In Example 14, the insulating fillers having the same hardness as the conductive particles and the particle diameter smaller than the conductive particles were contained. In Example 15, the insulating fillers having the same hardness as the conductive particles and the particle diameter larger than the conductive particles were contained. In both Examples 14 and 15, the initial conduction and the conduction reliability are favorable at a compression-bonding pressure that is over middle to high pressures.

As seen from comparison of Example 14 with Comparative Example 5, favorable results are obtained at a higher pressure in Example 14 as compared with Comparative Example 5, and the heating and pressurization condition is made wider. In comparison of Example 15 and Comparative Example 2, this trend is more remarkable.

### Examples 16 to 21

An anisotropic conductive film was produced and evaluated in the same manner as in Examples 10 to 15 except that the dispositions of the insulating fillers and the conductive particles were set to the arrangement patterns shown in FIG. 3. The results are shown in Table 3.

As seen from Table 3, the anisotropic conductive films of Examples 16 to 21 also exhibited favorable initial conduction resistance and conduction reliability. In particular, in the arrangement patterns shown in FIG. 3, since the conductive particles and the insulating fillers are alternately disposed with stability in a longitudinal direction of terminals, the capture properties of the conductive particles on the terminals are considered to be improved.

TABLE 3

| | | | Exam- | Exam- | Exam- | Exam- | Exam- | Exam- |
|---|---|---|---|---|---|---|---|---|
| | | Unit | ple 16 | ple 17 | ple 18 | ple 19 | ple 20 | ple 21 |
| Arrangement Patterns of Conductive Particles and | | | 3 | 3 | 3 | 3 | 3 | 3 |
| Insulating Fillers (Number of Drawing) | | | | | | | | |
| Conductive Particles | Conductive Particle | μm | 4 | 4 | 4 | 5 | 5 | 4 |
| | Diameter | | | | | | | |
| | Particle Hardness | N/mm² | 3500 | 3500 | 3500 | 3500 | 3500 | 3500 |
| | (20% K Value) | | | | | | | |
| | Conductive Property | — | Presence | Presence | Presence | Presence | Presence | Presence |
| | (Presence or | | | | | | | |
| | Absence of Plating) | | | | | | | |
| | Particle Areal Density | Particles/mm² | 4000 | 4000 | 4000 | 4000 | 4000 | 4000 |
| Insulating Fillers | Particle Diameter | μm | 3 | 3 | 3 | 3 | 3 | 5 |
| | Particle Hardness | N/mm² | 5000 | 9000 | 12000 | 9000 | 3500 | 3500 |
| | (20% K Value) | | | | | | | |
| | Particle Areal Density | Particles/mm² | 4000 | 4000 | 4000 | 4000 | 4000 | 4000 |
| Total Number of | Particle Areal Density | Particles/mm² | 8000 | 8000 | 8000 | 8000 | 8000 | 8000 |
| Particles | | | | | | | | |
| Evaluation | | | | | | | | |
| Heating and | Initial Conduction | | A | A | A | A | A | A |
| Pressurization Condition | Conduction Reliability (85° C., 85% RH, 500 hr.) | | A | A | B | A | A | A |
| 170° C./3 Mpa/5 sec. | Crushing of Particles | | A | A | B2 | B2 | A | A |
| 170° C./5 Mpa/5 sec. | Initial Conduction | | A | A | A | A | A | A |
| | Conduction Reliability (85° C., 85% RH, 500 hr.) | | A | A | A | A | A | A |
| | Crushing of Particles | | A | A | A | A | B1 | A |
| 170° C./8 Mpa/5 sec. | Initial Conduction | | A | A | A | A | A | A |
| | Conduction Reliability (85° C., 85% RH, 500 hr.) | | B | A | A | A | A | B |
| | Crushing of Particles | | B1 | A | A | A | B1 | B1 |
| 170° C./10 Mpa/5 sec. | Initial Conduction | | A | A | A | A | B | A |
| | Conduction Reliability (85° C., 85% RH, 500 hr.) | | B | A | A | A | C | B |
| | Crushing of Particles | | B1 | A | A | A | C1 | B1 |

### Examples 22 to 27

An anisotropic conductive film was produced and evaluated in the same manner as in Examples 10 to 15 except that the dispositions of the insulating fillers and the conductive particles were set to the arrangement patterns shown in FIG. 4. The results are shown in Table 4.

As seen from Table 4, the anisotropic conductive films of Examples 22 to 27 also exhibited favorable initial conduction resistance and conduction reliability. In particular, in the arrangement patterns shown in FIG. 4, since the total particle areal densities of the conductive particles and the insulating fillers are high as compared with the arrangement patterns of FIGS. 2 and 3, the insulating properties between the terminals and the capture properties of the conductive particles on each of the terminals are considered to be improved.

TABLE 4

| | | | Exam- | Exam- | Exam- | Exam- | Exam- | Exam- |
|---|---|---|---|---|---|---|---|---|
| | | Unit | ple 22 | ple 23 | ple 24 | ple 25 | ple 26 | ple 27 |
| Arrangement Patterns of Conductive Particles | | | 4 | 4 | 4 | 4 | 4 | 4 |
| and Insulating Fillers (Number of Drawing) | | | | | | | | |
| Conductive Particles | Conductive Particle | μm | 4 | 4 | 4 | 5 | 5 | 4 |
| | Diameter | | | | | | | |
| | Particle Hardness | N/mm² | 3500 | 3500 | 3500 | 3500 | 3500 | 3500 |
| | (20% K Value) | | | | | | | |
| | Conductive Property | — | Presence | Presence | Presence | Presence | Presence | Presence |
| | (Presence or | | | | | | | |
| | Absence of Plating) | | | | | | | |
| | Particle Areal Density | Particles/mm² | 4000 | 4000 | 4000 | 4000 | 4000 | 4000 |
| Insulating Fillers | Particle Diameter | μm | 3 | 3 | 3 | 3 | 3 | 5 |
| | Particle Hardness | N/mm² | 5000 | 9000 | 12000 | 9000 | 3500 | 3500 |
| | (20% K Value) | | | | | | | |
| | Particle Areal Density | Particles/mm² | 8000 | 8000 | 8000 | 8000 | 8000 | 8000 |
| Total Number of | Particle Areal Density | Particles/mm² | 12000 | 12000 | 12000 | 12000 | 12000 | 12000 |
| Particles | | | | | | | | |
| Evaluation | | | | | | | | |
| Heating and | Initial Conduction | | A | A | A | A | A | A |
| Pressurization Condition | Conduction Reliability (85° C., 85% RH, 500 hr.) | | A | A | B | A | A | B |
| 170° C./3 Mpa/5 sec. | Crushing of Particles | | B2 | B2 | C2 | B2 | B2 | B2 |
| 170° C./5 Mpa/5 sec. | Initial Conduction | | A | A | A | A | A | A |
| | Conduction Reliability (85° C., 85% RH, 500 hr.) | | A | A | A | A | A | A |
| | Crushing of Particles | | A | A | A | A | A | A |
| 170° C./8 Mpa/5 sec. | Initial Conduction | | A | A | A | A | A | A |
| | Conduction Reliability (85° C., 85% RH, 500 hr.) | | A | A | A | A | A | A |
| | Crushing of Particles | | A | A | A | A | A | A |
| 170° C./10 Mpa/5 sec. | Initial Conduction | | A | A | A | A | A | A |
| | Conduction Reliability (85° C., 85% RH, 500 hr.) | | A | A | A | A | B | B |
| | Crushing of Particles | | A | A | A | A | B1 | A |

### Examples 28 to 36

As shown in Table 5, an anisotropic conductive film was produced and evaluated in the same manner as in Examples 10 to 15 except that the dispositions of the insulating fillers and the conductive particles were set to the arrangement patterns shown in FIG. 5 or 6. The results are shown in Table 5.

As shown from Table 5, the anisotropic conductive films of Examples 28 to 30 having the arrangement patterns of FIG. 5 also exhibited favorable initial conduction resistance and conduction reliability under each of the heating and pressurization conditions. In the arrangement patterns of FIG. 5, the density of the insulating fillers is lower than the arrangement patterns of FIGS. 2 and 3. However, when the insulating fillers are harder, excessive crushing of the conductive particles can be prevented even at low density of the insulating fillers.

The anisotropic conductive films of Examples 31 to 36 having the arrangement patterns of FIG. 6 also exhibited favorable initial conduction resistance and conduction reliability, particularly when the pressure of the heating and pressurization condition is a higher pressure. In the arrangement patterns of FIG. 6, the density of the insulating fillers is higher than the arrangement patterns of FIGS. 2 and 3. Therefore, even when the hardness of the insulating fillers is similar to that of the conductive particles, excessive crushing of the conductive particles is prevented by the insulating fillers. The insulating properties between the terminals and the capture properties of the conductive particles on each of the terminals are considered to be improved.

TABLE 5

| | | | Exam- | Exam- | Exam- | Exam- | Exam- |
|---|---|---|---|---|---|---|---|
| | | Unit | ple 28 | ple 29 | ple 30 | ple 31 | ple 32 |
| Arrangement Patterns of Conductive Particles and | | | 5 | 5 | 5 | 6 | 6 |
| Insulating Fillers (Number of Drawing) | | | | | | | |
| Conductive Particles | Conductive Particle | μm | 4 | 4 | 5 | 4 | 4 |
| | Diameter | | | | | | |
| | Particle Hardness | N/mm² | 3500 | 3500 | 3500 | 3500 | 3500 |
| | (20% K Value) | | | | | | |
| | Conductive Property | — | Presence | Presence | Presence | Presence | Presence |
| | (Presence or | | | | | | |
| | Absence of Plating) | | | | | | |
| | Particle Areal Density | Particles/mm² | 4000 | 4000 | 4000 | 4000 | 4000 |
| Insulating Fillers | Particle Diameter | μm | 3 | 3 | 3 | 3 | 3 |
| | Particle Hardness | N/mm² | 9000 | 12000 | 9000 | 5000 | 9000 |
| | (20% K Value) | | | | | | |
| | Particle Areal Density | Particles/mm² | 1000 | 1000 | 1000 | 12000 | 12000 |
| Total Number of | Particle Areal Density | Particles/mm² | 5000 | 5000 | 5000 | 16000 | 16000 |
| Particles | | | | | | | |
| Evaluation | | | | | | | |
| Heating and | Initial Conduction | | A | A | A | A | A |
| Pressurization Condition | Conduction Reliability (85° C., 85% RH, 500 hr.) | | A | A | A | A | B |
| 170° C./3 Mpa/5 sec. | Crushing of Particles | | A | A | A | C2 | C2 |
| 170° C./5 Mpa/5 sec. | Initial Conduction | | A | A | A | A | A |
| | Conduction Reliability (85° C., 85% RH, 500 hr.) | | A | A | A | A | A |
| | Crushing of Particles | | A | A | A | B2 | B2 |
| 170° C./8 Mpa/5 sec. | Initial Conduction | | A | A | A | A | A |
| | Conduction Reliability (85° C., 85% RH, 500 hr.) | | A | A | A | A | A |
| | Crushing of Particles | | A | A | A | A | A |
| 170° C./10 Mpa/5 sec. | Initial Conduction | | A | A | A | A | A |
| | Conduction Reliability (85° C., 85% RH, 500 hr.) | | B | A | A | A | A |
| | Crushing of Particles | | B1 | B1 | B1 | A | A |

| | | | Exam- | Exam- | Exam- | Exam- |
|---|---|---|---|---|---|---|
| | | Unit | ple 33 | ple 34 | ple 35 | ple 36 |
| Arrangement Patterns of Conductive Particles and | | | 6 | 6 | 6 | 6 |
| Insulating Fillers (Number of Drawing) | | | | | | |
| Conductive Particles | Conductive Particle | μm | 4 | 5 | 5 | 4 |
| | Diameter | | | | | |
| | Particle Hardness | N/mm² | 3500 | 3500 | 3500 | 3500 |
| | (20% K Value) | | | | | |
| | Conductive Property | — | Presence | Presence | Presence | Presence |
| | (Presence or | | | | | |
| | Absence of Plating) | | | | | |
| | Particle Areal Density | Particles/mm² | 4000 | 4000 | 4000 | 4000 |
| Insulating Fillers | Particle Diameter | μm | 3 | 3 | 3 | 5 |
| | Particle Hardness | N/mm² | 12000 | 9000 | 3500 | 3500 |
| | (20% K Value) | | | | | |
| | Particle Areal Density | Particles/mm² | 12000 | 12000 | 12000 | 12000 |
| Total Number of | Particle Areal Density | Particles/mm² | 16000 | 16000 | 16000 | 16000 |
| Particles | | | | | | |
| Evaluation | | | | | | |
| Heating and | Initial Conduction | | A | A | B | A |
| Pressurization Condition | Conduction Reliability (85° C., 85% RH, 500 hr.) | | C | B | C | C |
| 170° C./3 Mpa/5 sec. | Crushing of Particles | | C2 | B2 | C2 | C2 |
| 170° C./5 Mpa/5 sec. | Initial Conduction | | A | A | A | A |
| | Conduction Reliability (85° C., 85% RH, 500 hr.) | | A | A | A | A |
| | Crushing of Particles | | B2 | A | B2 | B2 |
| 170° C./8 Mpa/5 sec. | Initial Conduction | | A | A | A | A |
| | Conduction Reliability (85° C., 85% RH, 500 hr.) | | A | A | A | A |
| | Crushing of Particles | | A | A | A | A |
| 170° C./10 Mpa/5 sec. | Initial Conduction | | A | A | A | A |

| Conduction Reliability (85° C., 85% RH, 500 hr.) | A | A | A | A |
|---|---|---|---|---|
| Crushing of Particles | A | A | A | A |

As seen from Examples, according to the anisotropic conductive film of the present invention, even when the pressure condition during thermo-compression bonding is varied in a production line of electronic appliance adopting anisotropic conductive connection, the occurrence of connection failure is suppressed.

### INDUSTRIAL APPLICABILITY

The anisotropic conductive film of the present invention has an insulating binder layer, conductive particles arranged in a regular pattern on a surface of the insulating binder layer, and an insulating adhesion layer layered on the surface of the insulating binder layer. In the insulating binder layer, insulating fillers are arranged in a regular pattern so as not to be overlapped with the conductive particles. For this reason, linking of the conductive particles can be suppressed and occurrence of short circuit can be largely suppressed without an increase in connection resistance. Further, suppression of breaking of the conductive particles on a bump during anisotropic conductive connection can be expected. Therefore, the anisotropic conductive film is useful in anisotropic conductive connection of an electronic component such as an IC chip to a wiring substrate.

### REFERENCE SIGNS LIST

1 insulating binder layer

2 conductive particle

3 insulating adhesion layer

4 insulating filler

50 transfer mold

51, 52 opening

51a first opening diameter

51b first opening depth

51c bottom diameter of first opening

52a second opening diameter

52b second opening depth

52c bottom diameter of second opening

60 release film

100 anisotropic conductive film

1. An anisotropic conductive film comprising: an insulating binder layer; conductive particles arranged in a regular pattern on a surface of the insulating binder layer; and an insulating adhesion layer layered on the surface of the insulating binder layer, wherein
in the insulating binder layer, insulating fillers are arranged in a regular pattern so as not to be overlapped with the conductive particles.

2. The anisotropic conductive film according to claim 1, wherein the conductive particles and the insulating fillers are locally located on the surface of the insulating binder layer.

3. The anisotropic conductive film according to claim 1, wherein the insulating fillers have an average particle diameter of 75% or less of that of the conductive particles.

4. The anisotropic conductive film according to claim 1, wherein the insulating fillers are softer than the conductive particles.

5. The anisotropic conductive film according to claim 1, wherein the insulating fillers are harder than the conductive particles, and the insulating fillers have an average particle diameter smaller than that of the conductive particles.

6. The anisotropic conductive film according to claim 1, wherein the insulating fillers are resin particles.

7. The anisotropic conductive film according to claim 1, wherein the insulating fillers are arranged between the conductive particles that are arranged in at least a film longitudinal direction.

8. The anisotropic conductive film according to claim 1, wherein the insulating fillers are arranged between the conductive particles that are arranged in at least a direction orthogonal to a film longitudinal direction.

9. The anisotropic conductive film according to claim 1, wherein the insulating fillers are arranged between the conductive particles that are arranged in a film longitudinal direction and between the conductive particles that are arranged in a direction orthogonal to the film longitudinal direction.

10. The anisotropic conductive film according to claim 1, comprising the insulating fillers that are arranged in a same direction as that of arrangement of the conductive particles, wherein a distance between the insulating fillers is larger than a distance between the conductive particles in the arrangement direction.

11. The anisotropic conductive film according to claim 1, comprising the insulating fillers that are arranged in the same direction as that of arrangement of the conductive particles, wherein a distance between the insulating fillers is smaller than a distance between the conductive particles in the arrangement direction.

12. The anisotropic conductive film according to claim 1, wherein the regular pattern of the conductive particles is a square lattice pattern, and the regular pattern of the insulating fillers is a face-centered square lattice pattern.

13. The anisotropic conductive film according to claim 1, wherein the regular pattern of the conductive particles is a square lattice pattern, the regular pattern of the insulating fillers is a square lattice pattern, and the conductive particles and the insulating fillers are alternately disposed in a longitudinal direction of the anisotropic conductive film.

14. The anisotropic conductive film according to claim 1, wherein the regular pattern of the conductive particles is a square lattice pattern, the regular pattern of the insulating fillers is a square lattice pattern, and the conductive particles and the insulating fillers are alternately disposed in a direction orthogonal to a longitudinal direction of the anisotropic conductive film.

15. The anisotropic conductive film according to claim 1, wherein a shortest distance between the adjacent conductive particles is 0.5 times or more an average particle diameter of the conductive particles.

16. The anisotropic conductive film according to claim 1, wherein another insulating adhesion layer is layered on another surface of the insulating binder layer.

17. A production method of the anisotropic conductive film according to claim 1, the method comprising the following steps (A) to (D):
Step (A)
a step of disposing the conductive particles in first openings of a transfer mold having the first openings for accommodating the conductive particles and second openings for accommodating the insulating fillers, with the first openings being formed in a regular pattern and the second openings being formed in a regular pattern so as not to be overlapped with the first openings, and disposing the insulating fillers in the second openings;
Step (B)
a step of providing the insulating binder layer formed on a release film so as to be opposed to a surface of the transfer mold on a side where the conductive particles and the insulating fillers are disposed;
Step (C)
a step of pushing the insulating binder layer into the first and second openings by applying a pressure to the insulating binder layer from a side of the release film, to transfer and attach the conductive particles and the insulating fillers to a surface of the insulating binder layer; and
Step (D)
a step of layering the insulating adhesion layer on the surface of the insulating binder layer to which the conductive particles and the insulating fillers are transferred and attached.

18. The production method according to claim 17, wherein, when an average particle diameter of the insulating filler is smaller than that of the conductive particles, the conductive particles are disposed in the first openings and then the insulating fillers are disposed in the second openings in the step (A).

19. The production method according to claim 17, further comprising, after the step (D), a step of layering another insulating adhesion layer on another surface of the insulating binder layer.

20. A connection structure in which a first electronic component and a second electronic component are connected by anisotropic conductive connection through the anisotropic conductive film according to claim 1.

21. A method of connecting a first electronic component and a second electronic component by anisotropic conductive connection through the anisotropic conductive film according to claim 1,
the method comprising temporarily adhering the anisotropic conductive film to the second electronic component from a side of the insulating binder layer, mounting the first electronic component on the anisotropic conductive film temporarily adhered, and thermo-compression bonding them from a side of the first electronic component.
